(19) United States
(12) Patent Application Publication
(10) Pub. No.: US 2012/0165010 A1
(43) Pub. Date: Jun. 28, 2012

(54) APPARATUS AND METHOD FOR AIRBORNE SELF-POWERED WIRELESS COMMUNICATION

(75) Inventors: Tae-Ho Lee, Daejeon-si (KR); Tae-Sang Choi, Daejeon-si (KR); Jin-Ho Hahm, Daejeon-si (KR); Paul Hongeuk Kim, Palo Alto, CA (US)

(73) Assignee: Electronics and Telecommunications Research Institute, Daejeon (KR)

(21) Appl. No.: 13/333,026

(22) Filed: Dec. 21, 2011

(30) Foreign Application Priority Data
Dec. 22, 2010 (KR) 10-2010-0132422

(51) Int. Cl. H04W 4/00

(52) U.S. Cl. 455/431

(57) ABSTRACT

An apparatus and method for airborne self-powered wireless communication is provided. The airborne wireless communication apparatus is fixed to an airborne platform including an aerostat, which maintains a constant altitude in air, uses an airborne wind power turbine as a power generating source, and supports an air-to-air wireless communication and an air-to-ground wireless communication by use of a mesh network.

### CROSS-REFERENCE TO RELATED APPLICATION

This application claims the benefit under 35 U.S.C. §119(a) of Korean Patent Application No. 10-2010-0132422, filed on Dec. 22, 2010, the disclosure of which is incorporated by reference in its entirety for all purposes.

### BACKGROUND

1. Field

The following description relates to a network based technology and a network platform technology, and more particularly, to an airborne wireless communication technology.

2. Description of the Related Art

A high altitude long operation (HALO) system is configured to provide a high speed broadband communication service by use of an aerostat having a function of a transmitting/receiving tower at a high altitude. A high altitude platform station (HAPS) represents a wireless base station installed on an object, such as a platform, that is disposed at a fixed point at a predetermined height of about 20 to 50 km above the ground. The HAPS provides a communication in a broad service area by floating an aerostat on the stratosphere (a height of about 20 to 50 km). Launching an artificial satellite is a big project, taking enormous money. Even in installing a low earth orbit satellite system, several tens of satellites are required to be launched, not to mention a geostationary satellite having a weight of 3 to 4 tones. As an alternative to the costly satellite, a platform communication system using an airship has been proposed. Since the platform communication system is achieved at a low altitude, a communication path is set to be short, thereby ensuring a stable communication.

### SUMMARY

In one aspect, there is provided a self powered wireless communication technology capable of supporting an air-to-air direct wireless communication and an air-to-ground direct wireless communication in mid-air regions where a basic communication infrastructure is missing or creating or reconstructing a basic communication infrastructure is complicated.

In one general aspect, there is provided an airborne wireless communication apparatus that is supported by an airborne platform including an aerostat, the airborne wireless communication apparatus including: a power generator configured to generate electric power for a communication of the airborne wireless communication by use of an airborne wind power turbine; an air-to-air communicator comprising at least one antenna to transmit and receive a communication signal with respect to another airborne wireless communication apparatus; and a controller configured to form a mesh network in cooperation with another airborne wireless communication apparatus and control a direct wireless communication with the other wireless communication apparatus through the air-to-air communicator. The airborne wireless communication may further include an air-to-ground communicator configured to serve as a portable base station and comprises at least one antenna to transmit and receive a communication signal with respect to a ground based wireless switching center or a wireless terminal on the ground.

In another general aspect, there is provided an airborne wireless communication method for an airborne wireless communication apparatus that is supported by an airborne platform including an aerostat, the airborne wireless communication method including: generating electric power for a communication of the airborne wireless communication apparatus by use of an airborne wind power turbine; and forming a mesh network in cooperation with another airborne wireless communication apparatus, thereby performing an airborne wireless communication with respect a nearby airborne wireless communication apparatus corresponding to a nearby router.

In another general aspect, there is provided an airborne wireless communication method between communication terminals by use of an airborne wireless communication apparatus that is supported by an airborne platform including an aerostat, the airborne wireless communication method including: at a first communication terminal within a service region of a first airborne wireless communication apparatus, attempting to perform a communication with respect to a second communication terminal within a service region of a second airborne wireless communication apparatus; at the first airborne wireless communication apparatus, forming a mesh network in cooperation with at least one airborne wireless communication apparatus disposed between the first airborne wireless communication apparatus and the second airborne wireless communication apparatus; and at the first airborne wireless communication apparatus, transmitting a communication signal to the second airborne wireless communication apparatus via at least one nearby airborne wireless communication network corresponding to a nearby router among the at least one airborne wireless communication network, thereby achieving a communication between the first communication terminal and the second communication terminal.

In another general aspect, there is provided an airborne wireless communication method between communication terminals by use of an airborne wireless communication apparatus that is supported by an airborne platform including an aerostat, the airborne wireless communication method including: at a first communication terminal within a service region of a first airborne wireless communication apparatus, attempting to perform a communication with a second communication terminal which is disposed outside an airborne wireless network service region; at the first airborne wireless communication apparatus, forming a mesh network in cooperation with at least one airborne wireless communication apparatus that is disposed between the first airborne wireless communication apparatus and a second airborne wireless communication apparatus serviced from a ground base station; at the first airborne wireless communication apparatus, transmitting a communication signal to the second airborne wireless communication apparatus via at least nearby airborne wireless communication apparatus corresponding to a nearby router among the at least one airborne wireless communication network, thereby establishing a communication between the first communication terminal and the ground base station; and connecting the first communication terminal to the second communication terminal through the ground base station.

As described above, an airborne wireless communication apparatus is mounted on an aerostat and serves as a minimum sized router, thereby achieving an air-to-air direct wireless communication.

In addition, an airborne wireless communication apparatus is mounted on a self-powered aerostat using wind power, thereby achieving self power generation.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 shows the configuration of an example of an airborne wireless communication apparatus.

FIG. 2 shows the mechanism of an example of an airborne wireless communication apparatus.

FIG. 3 shows the mechanism of another example of an airborne wireless communication apparatus.

FIG. 4 shows an air-to-air wireless communication process according to an example of an airborne wireless communication apparatus.

FIG. 5 shows an airborne wireless communication between communication terminals by use of an airborne wireless communication apparatus that is supported by an airborne platform including an aerostat.

FIG. 6 shows the control flow of a wireless communication method of an airborne wireless communication apparatus that is supported by an airborne platform including an aerostat.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

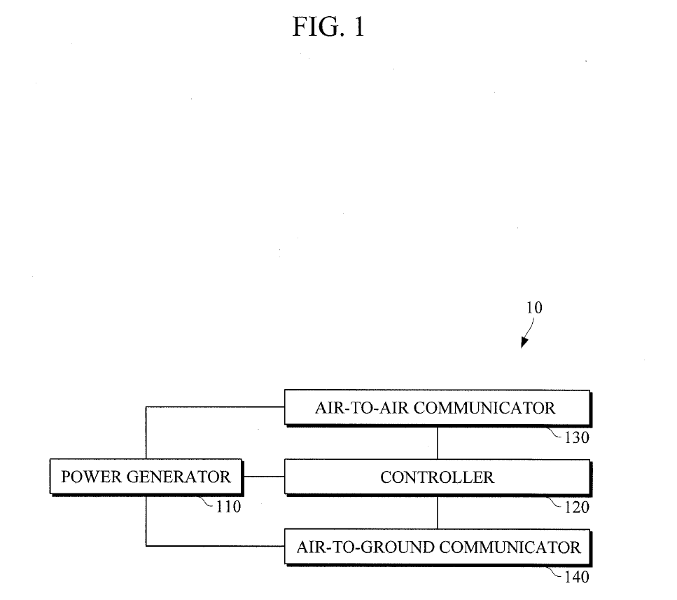

FIG. 1 shows the configuration of an example of an airborne wireless communication apparatus.

As shown in FIG. 1, an airborne wireless communication apparatus 10 includes a power generator 110, a controller 120 and an air-to-air communicator 130, and may further include an air-to-ground communicator 140.

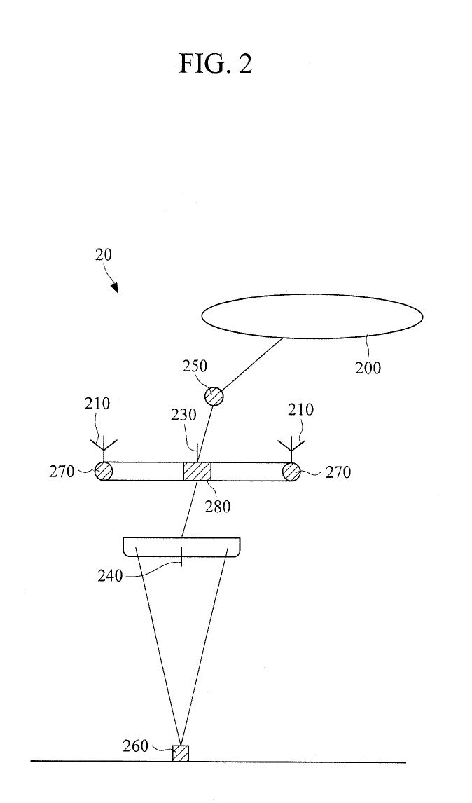

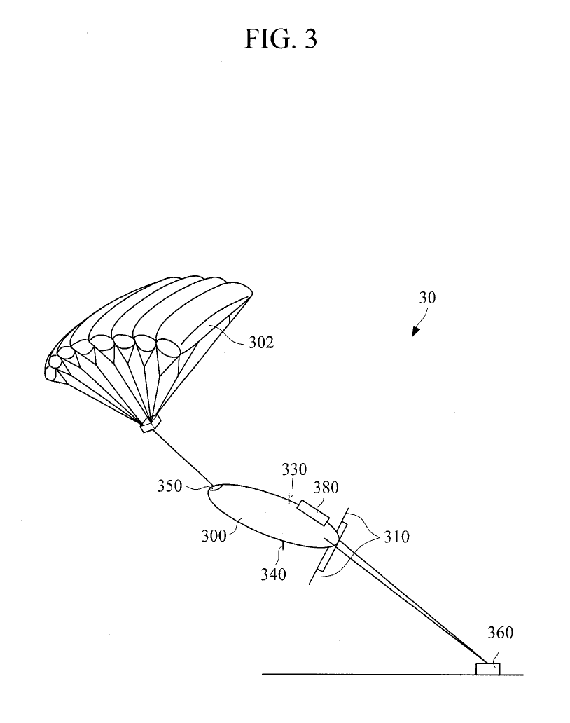

The airborne wireless communication apparatus 10 is supported by an airborne platform including an aerostat. An example of the airborne platform may include a low altitude balloon and is described below with reference to FIG. 2. Another example of the airborne platform may include a parafoil and is described below with reference to FIG. 3. Another example of the airborne platform may include an aircraft. The configuration of the airborne platform may be limited thereto and implemented in various forms.

The airborne wireless communication apparatus 10 is fixed to an airborne platform including an aerostat, which maintains a constant altitude in air, and uses an airborne wind power turbine as a power generating source. In addition, the airborne wireless communication apparatus 10 supports an air-to-air wireless communication and an air-to-ground wireless communication by use of a mesh network.

The airborne wireless communication apparatus 10 is a low altitude communication system. In general, a high altitude communication system uses a ground based wireless switching center and an airborne wireless base station. In this case, the airborne wireless base station provides a cellular coverage to a user on the ground. In addition, the airborne wireless base station communicates with the ground through the ground based wireless switching center. Accordingly, the airborne wireless base station communicates with another airborne wireless base station through the ground based wireless switching center. Different from the high altitude communication system, the low altitude communication system directly performs a wireless communication with a communication apparatus existing on the ground by use of an air-to-air mesh network and an air-to-ground communication module.

In addition, the high altitude communication system uses an active flying device, which can communicates with a user on the ground but does not a capability to self-generate power. Accordingly, the high altitude communication system has a difficulty in staying in air for long hours. Different from such a high altitude communication system, the low altitude communication system can self generate the power it needs.

Hereinafter, each component of the airborne wireless communication apparatus 10 will be described in detail with reference to FIG. 1.

In detail, the power generator 110 supplies an electric power to an airborne platform including an aerostat. In addition, the power generator 110 supplies an electric power, which is required for a communication of the airborne wireless communication apparatus 10, through an airborne wind power turbine. The power generator 110 rotates the airborne wind power turbine while being mounted on the airborne platform to generate an electric power and turn a movement of wind forming an airstream into energy.

In general, an airborne wind power generation technology focuses on efficient and reliable power generation and on the transfer of the generated power to the ground with minimum loss. The power generator 110 is similar to the general airborne wind power generation technology in using stable and strong wind. However, the power generator 110 is further configured to provide the power required for the air-to-air communicator 130 and the air-to-ground communicator 140 through a self-generation of the airborne wireless communication apparatus 10 rather than transferring the generated power to the ground.

The air-to-air communicator 130 includes at least one antenna to transmit and receive a communication signal with respect to another airborne wireless communication apparatus. The air-to-ground communicator 140 serves as a portable base station, and includes at least one antenna to transmit and receive a communication signal with respect to a ground based wireless switching center or a wireless terminal on the ground. The controller 120 provides an interface for a compatibility between the air-to-air communicator 130 and the air-to-ground communicator 140.

The controller 120 is configured to form a mesh network conforming to IEEE 802.11s standards in cooperation with another airborne wireless communication apparatus, thereby directly controlling a wireless communication with the other airborne wireless communication apparatus. In this case, the controller 120 allows the airborne wireless communication apparatus 10 to serve as a mesh router such that a communication signal is directly transmitted to a nearby airborne wireless communication apparatus corresponding to a nearby router in a wireless scheme through the air-to-air communicator 130, thereby supporting a wireless communication between communication terminals that are connected to the airborne wireless communication apparatus 10 in a cell.

Conventional wireless communication devices for a wind power generator have been focused on monitoring the amount of power output by the turbines or adjusting the pitch and direction of the rotors of the turbine for more efficient power generation. In other words, the conventional wireless communication devices are used as supplementary devices to enhance the power generation of the turbine.

However, the example of the airborne wireless communication apparatus 10 is used as a basic network infrastructure that operates as a self-configurable mesh network. In particular, the example of the airborne wireless communication apparatus 10 forms a self-configurable mesh network through the air-to-air communicator 130, and achieves self-power generation through the power generator 110.

FIG. 2 shows the mechanism of an example of an airborne wireless communication apparatus.

As shown in FIG. 2, an airborne wireless communication apparatus 20 is supported by an airborne platform including an aerostat. In this case, the aerostat may represent a low altitude balloon 200 as shown in FIG. 2. To maximize the lift of the low altitude balloon, the low altitude balloon 200 is made as aerodynamic as possible. The low altitude balloon 200 does not use any motor or any other mechanism to maintain a constant position and altitude.

The power generator 210 supplies an electric power for a communication of the airborne wireless communication apparatus 20 through an airborne wind power turbine. That is, the power generator 210 rotates an airborne wind power turbine while being mounted on the airborne platform to generate an electric power and turn a movement of wind forming an airstream into energy.

An air-to-air communicator 230 includes at least one antenna to form a mesh network in cooperation with another airborne wireless communication apparatus. The example of the airborne wireless communication apparatus 20 uses a mesh network conforming to IEEE 802.11s standards. However, the airborne wireless communication apparatus 20 is not limited thereto, may use various types of mesh network schemes. An air-to-ground communicator 240 serves as a portable base station by including at least one antenna to transmit and receive a communication signal with respect to a communication terminal on the ground or a ground based wireless switching center. This example uses Global System for mobile communication (GSM) but not limited thereto. The controller (not shown) provides an interface for compatibility between the air-to-air communicator 230 and the air-to-ground communicator 240.

A plane-mounted retractor 250 is configured to anchor the airborne platform including the aerostat in air. A ground retractor 260 is configured to anchor the airborne platform including the aerostat to the ground. The controller (not shown) controls the plane-mounted retractor 250 and the ground retractor 260 such that the airborne platform including the aerostat is anchored at a predetermined altitude that is preliminarily set based on both of the air and the ground.

An airborne wind power turbine protector 270 is configured to control the generation of power that is achieved through the airborne wind power turbine of the power generator 210, keep a rotor of the airborne wind power turbine in perpendicular to a wind, and protect the airborne wind power turbine from wind when required. A battery 280 supplies an electric power to the airborne platform including the aerostat.

FIG. 3 shows the mechanism of another example of an airborne wireless communication apparatus.

As shown in FIG. 3, an airborne wireless communication apparatus 30 is supported by an airborne platform including an aerostat. The airborne platform may include helium-filled aeroplane 300 and a parafoil 302. The parafoil 302 is made as aerodynamic as possible to maximize the lift. In this case, the parafoil 302 does not use any motor or any other mechanism to maintain a constant position and altitude.

A power generator 310 supplies an electric power for a communication of the airborne wireless communication apparatus 30 through an airborne wind power turbine. That is, the power generator 310 rotates an airborne wind power turbine while being mounted on the airborne platform to generate an electric power and turn a movement of wind forming an airstream into energy.

An air-to-air communicator 330 includes at least one antenna to form a mesh network in cooperation with another airborne wireless communication apparatus, in which the mesh network conforms to IEEE 802.11s standards. An air-to-ground communicator 340 includes at least one antenna to transmit and receive a communication signal with respect to a wireless terminal on the ground or a ground based wireless switching center, thereby serving as a portable base station for Global System for mobile communication (GSM). The controller (not shown) provides an interface for compatibility between the air-to-air communicator 330 and the air-to-ground communicator 340.

A plane-mounted retractor 350 is configured to anchor the airborne platform including the aerostat in air. A ground retractor 360 is configured to anchor the airborne platform including the aerostat to the ground. The controller (not shown) controls the plane-mounted retractor 350 and the ground retractor 360 such that the airborne platform including the aerostat is anchored at a predetermined altitude that is preliminarily set based on both of the air and the ground. A battery 380 stores an electric power that is generated by the power generator 310.

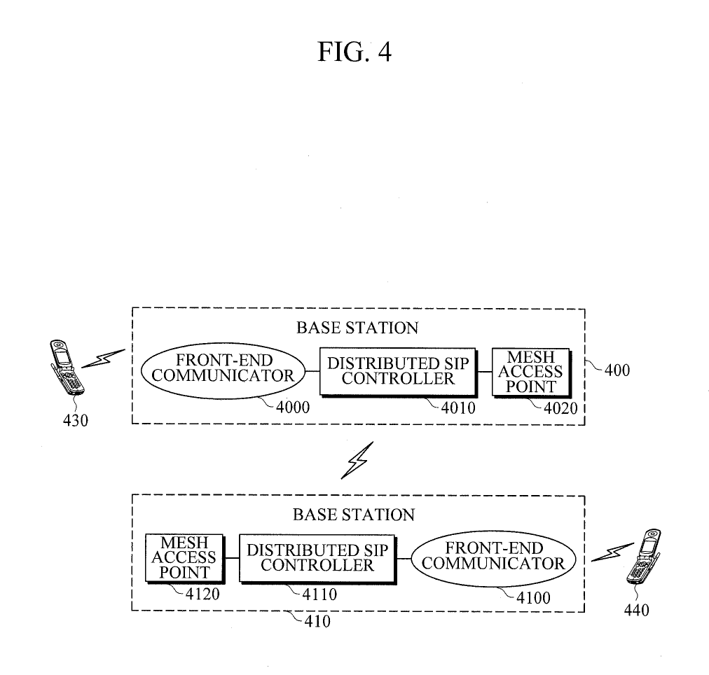

FIG. 4 shows an air-to-air wireless communication process according to an example of an airborne wireless communication apparatus.

As shown in FIG. 4, a transmitting base station 400 includes a Front-end communication unit 4000 configured to covert a GSM signal to a Session Initiation Protocol (SIP) signal, a distributed SIP controller 4010 and a mesh access point (Mesh AP) 4020. A receiving base station 410 includes a Front-end communication unit 4100, a distributed SIP controller 4110 and a Mesh AP 4120. The transmitting base station 400 performs an air-to-air wireless communication with the receiving base station 410 by use of the Front-end communication unit 4000, the distributed SIP controller 4010 and the Mesh AP 4020. Accordingly, a transmitting terminal 430 supported by the transmitting base station 400 achieves a call connection with a receiving terminal 440 supported by the receiving base station 410. In this case, the air-to-air wireless communication is performed through a mesh network between the transmitting base station 400 and the receiving base station 410.

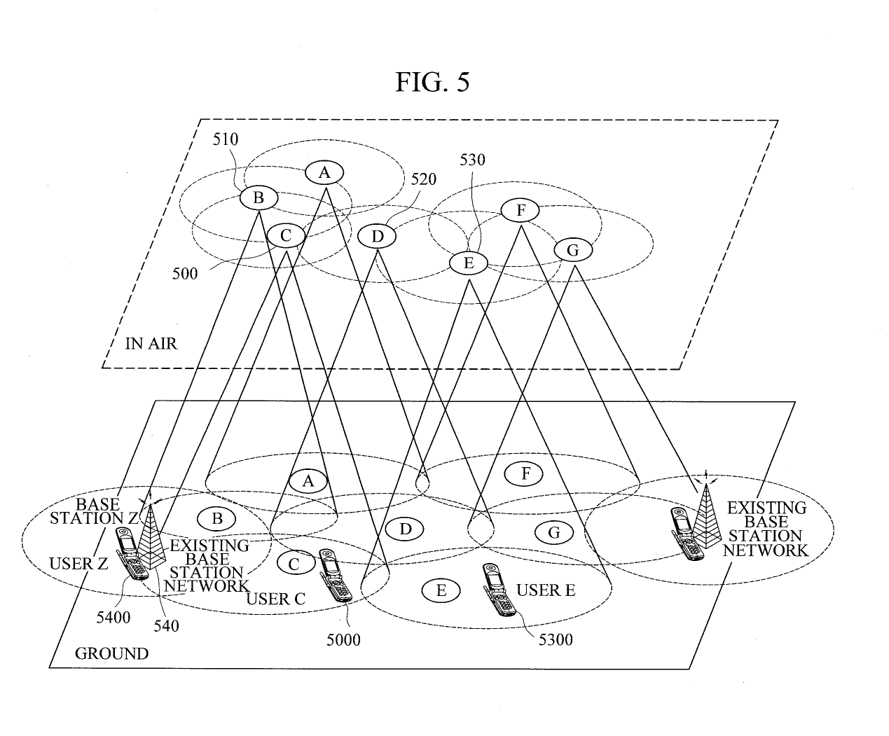

FIG. 5 shows an airborne wireless communication between communication terminals by is use of an airborne wireless communication apparatus that is supported by an airborne platform including an aerostat.

The airborne wireless communication is implemented in an environment where a basic communication infrastructure is missing or creating or reconstructing a basic communication infrastructure is complicated.

For example, a first communication terminal within a service region of a first airborne wireless communication apparatus attempts to communicate with a second communication terminal within a service region of a second airborne wireless communication apparatus. In this case, the first airborne wireless communication apparatus forms a mesh network in cooperation with at least one airborne wireless communication apparatus disposed between the first airborne wireless communication apparatus and the second airborne wireless communication apparatus.

Thereafter, the first airborne wireless communication apparatus transmits a communication signal to the second airborne wireless communication apparatus via at least one nearby airborne wireless communication network corresponding to a nearby router among the at least one airborne wireless communication network, thereby achieving a communication between the first communication terminal and the second communication terminal. The first airborne wireless communication apparatus, the second airborne wireless communication apparatus and the at least one airborne wireless communication apparatus disposed between the first airborne wireless communication apparatus and the second airborne wireless communication apparatus receive electric power for a wireless communication through an airborne wind power turbine.

For example, a first communication terminal within a service region of a first airborne wireless communication apparatus attempts to communicate a second communication terminal which is disposed outside an airborne wireless network service region. In this case, the first airborne wireless communication apparatus forming a mesh network in cooperation with at least one airborne wireless communication apparatus that is disposed between the first airborne wireless communication apparatus and a second airborne wireless communication apparatus that services a ground base station. Thereafter, the first airborne wireless communication apparatus transmits a communication signal to the second airborne wireless communication apparatus via at least nearby airborne wireless communication apparatus corresponding to a nearby router among the at least one airborne wireless communication network, thereby establishing a communication connecting between the first communication terminal and the ground base station. Finally, the first communication terminal is connected to the second communication terminal through the ground base station. The first airborne wireless communication apparatus, the second airborne wireless communication apparatus and the at least one airborne wireless communication apparatus disposed between the first airborne wireless communication apparatus and the second airborne wireless communication apparatus receive electric power for a wireless communication through an airborne wind power turbine.

Hereinafter, a wireless communication process between communication terminals by use of the above airborne wireless communication apparatus will be described in detail with reference to FIG. 5.

As an example, it is assumed that a user C (5000) existing in a service region of an aerostat C 500 wants a communication with a user E 5300 existing in a service region of an aerostat E 530. If the user C 5000 attempts a communication with the user E 5300, a communication is serviced from the aerostat C 500 and then routed to the aerostat E 530 via an aerostat E 520. Finally, the communication is connected from the aerostat E 530 to the user E 5300.

As another example, it is assumed that the user C 5000 wants to communicate with a user Z 5400 existing outside a service region of aerostats. A communication is serviced from the aerostat C 5000, and then routed to an aerostat B 510. The aerostat B 510 routes the communication to a base station Z 540 disposed in a service region of the aerostat B 510. Finally, a communication is serviced to the user Z 5400 from the base station Z 540.

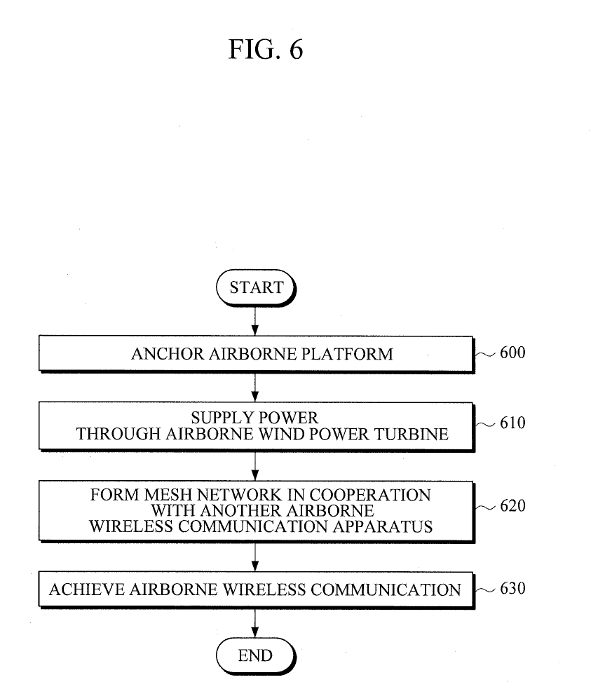

FIG. 6 shows the control flow of a wireless communication method of an airborne wireless communication apparatus that is supported by an airborne platform including an aerostat.

As shown in FIG. 6, an airborne platform including an aerostat is anchored at a predetermined altitude that is preliminarily set based on both of the air and the ground (600). Then, an electric power for a communication of the airborne wireless communication apparatus is supplied through an airborne wind power turbine (610). Thereafter, the airborne wireless communication apparatus forms a mesh network in cooperation with another airborne wireless communication apparatus (620) to perform an airborne wireless communication with a nearby airborne wireless communication apparatus corresponding to a nearby router (630). Further, the airborne wireless communication apparatus transmits and receives a communication signal with respect to a ground based wireless switching center or a terminal on the ground, thereby communicating with the ground.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An airborne wireless communication apparatus that is supported by an airborne platform including an aerostat, the airborne wireless communication apparatus comprising:
a power generator configured to generate electric power for a communication of the airborne wireless communication by use of an airborne wind power turbine;
an air-to-air communicator comprising at least one antenna to transmit and receive a communication signal with respect to another airborne wireless communication apparatus; and
a controller configured to form a mesh network in cooperation with another airborne wireless communication apparatus and control a direct wireless communication with the other wireless communication apparatus through the air-to-air communicator.

2. The airborne wireless communication of claim 1, wherein the controller allows the airborne wireless communication apparatus to serve as a mesh router such that a communication signal is directly transmitted to a nearby airborne wireless communication apparatus corresponding to a nearby router in a wireless scheme through the air-to-air communicator, thereby supporting a wireless communication between communication terminals that are connected to the airborne wireless communication apparatus and the nearby wireless communication apparatus, respectively, in a cell.

3. The airborne wireless communication of claim 1, further comprising an air-to-ground communicator configured to serve as a portable base station and comprises at least one antenna to transmit and receive a communication signal with respect to a ground based wireless switching center or a wireless terminal on the ground.

4. The airborne wireless communication apparatus of claim 3, wherein the controller provides an interface for a compatibility between the air-to-air communicator and the air-to-ground communicator.

5. The airborne wireless communication apparatus of claim 1, wherein the power generator rotates the airborne wind power turbine while being mounted on the airborne platform to generate an electric power and turn a movement of wind forming an airstream into energy.

6. The airborne wireless communication apparatus of clam 1, further comprising:
an airborne wind power turbine protector configured to control the generation of power, which is achieved through the airborne wind power turbine of the power generator, keep a rotor of the airborne wind power turbine in perpendicular to a wind, and protect the airborne wind power turbine when required.

7. The airborne wireless communication apparatus of clam 1, further comprising:
a plane-mounted retractor configured to anchor the airborne platform including the aerostat in air; and
an ground retractor configured to anchor the airborne platform including the aerostat to the ground.

8. The airborne wireless communication apparatus of claim 7, wherein the controller controls the plane-mounted retractor and the ground retractor such that the airborne platform including the aerostat is anchored at a predetermined altitude that is preliminarily set based on both of the air and the ground.

9. The airborne wireless communication apparatus of claim 1, further comprising a battery configured to store the electric power that is generated through wind generation by the power generator.

10. The airborne wireless communication apparatus of claim 1, wherein the airborne platform comprises at least one low altitude balloon.

11. The airborne wireless communication apparatus of claim 1, wherein the airborne platform comprises at least one parafoil.

12. The airborne wireless communication apparatus of claim 1, wherein the airborne platform comprises at least one aerostat.

13. An airborne wireless communication method for an airborne wireless communication apparatus that is supported by an airborne platform including an aerostat, the airborne wireless communication method comprising:
generating electric power for a communication of the airborne wireless communication apparatus by use of an airborne wind power turbine; and
forming a mesh network in cooperation with another airborne wireless communication apparatus, thereby performing an airborne wireless communication with respect a nearby airborne wireless communication apparatus corresponding to a nearby router.

14. The airborne wireless communication method of claim 13, further comprising
anchoring the airborne platform including the aerostat at a predetermined altitude that is preliminarily set based on both of the air and the ground.

15. The airborne wireless communication method of claim 13, further comprising transmitting and receiving a communication signal with respect to a wireless terminal disposed on the ground.

16. An airborne wireless communication method between communication terminals by use of an airborne wireless communication apparatus that is supported by an airborne platform including an aerostat, the airborne wireless communication method comprising:
at a first communication terminal within a service region of a first airborne wireless communication apparatus, attempting to perform a communication with respect to a second communication terminal within a service region of a second airborne wireless communication apparatus;
at the first airborne wireless communication apparatus, forming a mesh network in cooperation with at least one airborne wireless communication apparatus disposed between the first airborne wireless communication apparatus and the second airborne wireless communication apparatus; and
at the first airborne wireless communication apparatus, transmitting a communication signal to the second airborne wireless communication apparatus via at least one nearby airborne wireless communication network corresponding to a nearby router among the at least one airborne wireless communication network, thereby achieving a communication between the first communication terminal and the second communication terminal.

17. The airborne wireless communication method of claim 16, wherein the first airborne wireless communication apparatus, the second airborne wireless communication apparatus and the at least one airborne wireless communication apparatus disposed between the first airborne wireless communication apparatus and the second airborne wireless communication apparatus receive electric power for a wireless communication through an airborne wind power turbine.

18. An airborne wireless communication method between communication terminals by use of an airborne wireless communication apparatus that is supported by an airborne platform including an aerostat, the airborne wireless communication method comprising:
at a first communication terminal within a service region of a first airborne wireless communication apparatus, attempting to perform a communication with a second communication terminal which is disposed outside an airborne wireless network service region;
at the first airborne wireless communication apparatus, forming a mesh network in cooperation with at least one airborne wireless communication apparatus that is disposed between the first airborne wireless communication apparatus and a second airborne wireless communication apparatus serviced from a ground base station;
at the first airborne wireless communication apparatus, transmitting a communication signal to the second airborne wireless communication apparatus via at least nearby airborne wireless communication apparatus corresponding to a nearby router among the at least one airborne wireless communication network, thereby establishing a communication between the first communication terminal and the ground base station; and
connecting the first communication terminal to the second communication terminal through the ground base station.

19. The airborne wireless communication method of claim 18, wherein the first airborne wireless communication apparatus, the second airborne wireless communication apparatus and the at least one airborne wireless communication apparatus disposed between the first airborne wireless communication apparatus and the second airborne wireless communication apparatus receive electric power for a wireless communication through an airborne wind power turbine.
